(19) United States
(12) Patent Application Publication
(10) Pub. No.: US 2020/0029518 A1
(43) Pub. Date: Jan. 30, 2020

(54) DEVICE TO INSERT A WICK INTO A PLANT POT, ASSEMBLY OF DEVICE AND WICK, AND PRODUCTION METHOD OF THE DEVICE

(71) Applicant: Waterwick B.V., 'S-Gravendeel, KH (NL)

(72) Inventor: Anthony VISSER, 'S-Gravendeel (NL)

(73) Assignee: Waterwick B.V., 'S-Gravendeel, KH (NL)

(21) Appl. No.: 16/477,236

(22) PCT Filed: Jan. 22, 2018
(86) PCT No.: PCT/NL2018/050042

§ 371 Date: Jul. 11, 2019

(30) Foreign Application Priority Data
Jan. 23, 2017 (NL) 2018209

(51) Int. Cl. A01G 27/04

(52) U.S. Cl. CPC A01G 27/04

(57) ABSTRACT

A device to insert a wick into a plant pot, an assembly of the device and the wick, as well as a method of making the device. The device is configured to insert a wick in substrate contained in a plant pot, and comprises an elongate body, and at least one wick clamp configured to engage a wick at at least one longitudinal end of the elongate body. The clamp extends over a considerable portion of the length and optionally over essentially the whole length of the elongate body. Wicks may be assembled with the device automatically or manually.

The present disclosure relates to a wick inserting device, an assembly of the device and the wick, and a production method thereof. Such a wick inserting device may be used to insert a wick in substrate contained in a plant pot. Most often such wick inserting devices are pushed into substrate in a plant pot, for example through a hole in a bottom of such a plant pot.

Wick inserting devices known from for example CA-2026590 are however usually very complex, shapely and costly to produce. For example, known devices have a stop at one longitudinal end, in the form of a disk, and a clamp at the opposing end. Additionally or alternatively, as known from U.S. Pat. No. 5,193,305, wick inserting devices may have wing-like extensions extending from a core body with barbs to engage an inner edge of a hole in a bottom of the plant pot and prevent unintended withdrawal and/or excessive insertion of the known devices. This requires stamping and excessive material usage and waste, which makes the known devices expensive to produce. The device of U.S. Pat. No. 5,193,305, like the one of CA-2016590, has a clamp at one end opposite the end with the barb(s). Known wick inserting devices exhibit a common disadvantage that a wick can easily come loose from the clamp in the course of being inserted into a plant pot and through the bottom thereof, which occurs easily and often, and if this occurs, the device and the wick have to be separately extracted to be re-joined and re-inserted.

According to a first aspect of the present disclosure such wick inserting devices comprising, in contrast with prior devices: an elongate body; and at least one wick clamp configured to engage a wick at at least one longitudinal end of the elongate body. Thus the design of the devices may excel in simplicity, resulting in less material required for production and even in some embodiments allow continuous extrusion for production, to minimize production costs, where simultaneously an improvement in secure engagement of the wick is achieved. In particular, the clamp effectively extends over a considerable portion and optionally essentially the whole length of the elongate body. This facilitates a constant design over the entire length of the device, resulting in a simplification of the design and reduction of production efforts, costs, material usage and moreover also material waste. Moreover, the sought improvement in secure engagement of the wick is simultaneously achieved.

Devices according to the present disclosure may be furnished in any one of a large number of preferred and/or potential embodiments, which are described below and/or defined in appended dependent claims.

In an additional or alternative embodiment the clamp may define an integral part of the elongate body. This contributes to a simple design and low production effort.

In an additional or alternative embodiment the clamp may comprise in cross section, relative to the longitudinal direction of the elongate body, at least one curved arm, defining a wick accommodation in a curvature of the curved arm. In such an embodiment the curved arm may span an angle of at least 180 degrees in radial direction, relative to a central axis of the elongate body. Likewise, in such an embodiment, the curved arm may span an angle of considerably less than 360 degrees in radial direction, relative to a central axis of the elongate body. Since in use liquid is drawn up through the wick to supply the liquid to relatively high positions in the plant pot, the arm should span a sufficient angle to effectively engage the wick and simultaneously allow dissemination of drawn up liquids into surrounding substrate.

In an additional or alternative embodiment the clamp may comprise at least one inward oriented hook. This contributes to effectively engaging the wick and preventing the wick from coming loose from the wick clamp.

In an additional or alternative embodiment, a cross sectional shape of the elongate body, relative to the longitudinal direction of the elongate body, may be the same at each location along the entire length of the elongate body.

In an additional or alternative embodiment at least one longitudinal end of the elongate body may be pointed. This may contribute to easy insertion of a pointed end into the substrate.

In an additional or alternative embodiment the elongate body may be an extrusion product.

According to a second aspect of the present disclosure such a production method of furnishing wick inserting devices comprised, in contrast with prior devices: providing an elongate body; and arranging at least one wick clamp configured to engage a wick at a longitudinal end of the elongate body.

Methods according to the present disclosure may be furnished in any one of a large number of preferred and/or potential embodiments, which are described below and/or defined in appended dependent claims.

In a preferred embodiment the method may comprise engaging a wick with the wick clamp. This way an assembly may be provided that is ready to use by consumers or plant breeders alike.

In a preferred embodiment the method may exhibit a feature that providing the elongate body comprises extruding the elongate body. In such an embodiment, the method may further comprise extruding an extrusion product in a continuous production process and severing predetermined lengths of the extrusion product to successively provide a plurality of elongate bodies.

In an embodiment with assembling the wick and the device and continuous extrusion arranging the wick in the wick clamp may comprise rolling the wick into the wick clamp.

An embodiment with assembling the wick and the device, continuous extrusion and rolling the wick into the wick clamp may comprise rolling the wick into the wick clamp prior to severing the predetermined lengths of the extrusion product to successively provide a plurality of elongate bodies with wicks of equal length as the elongate bodies engaged by the wick clamp.

Alternatively, in an embodiment exhibiting engaging a wick with the wick clamp, the method may further comprise providing a longer wick than a length of the elongate body and engaging the wick with the wick clamp in a relative position of the wick and the elongate body wherein the wick extends from the elongate body at at least one longitudinal end of the elongate body. In such an embodiment, the method may comprise providing the longer wick with a longitudinal end thereof to essentially coincide with a longitudinal end of the elongate body.

Additionally or alternatively the clamp may be arranged to extend over essentially the whole length of the elongate body.

Following the foregoing indication of features of embodiments of the present disclosure in runner generic terms, corresponding with the wordings of the appended claims, herein below exemplary embodiments will be disclosed in more technical detail, referring to the appended drawings, where it is noted, that the scope of protection for the present disclosure is by no means to be limited to specific features of the following description or in the appended drawings, unless the appended independent claims are limited to such features and where it is further noted that even equivalent features relative to those defined in the independent claims are potentially also encompassed by the scope of protection. In the appended drawing:

FIG. 1 discloses a perspective view of a first embodiment of a Wick inserting device according to the present disclosure;

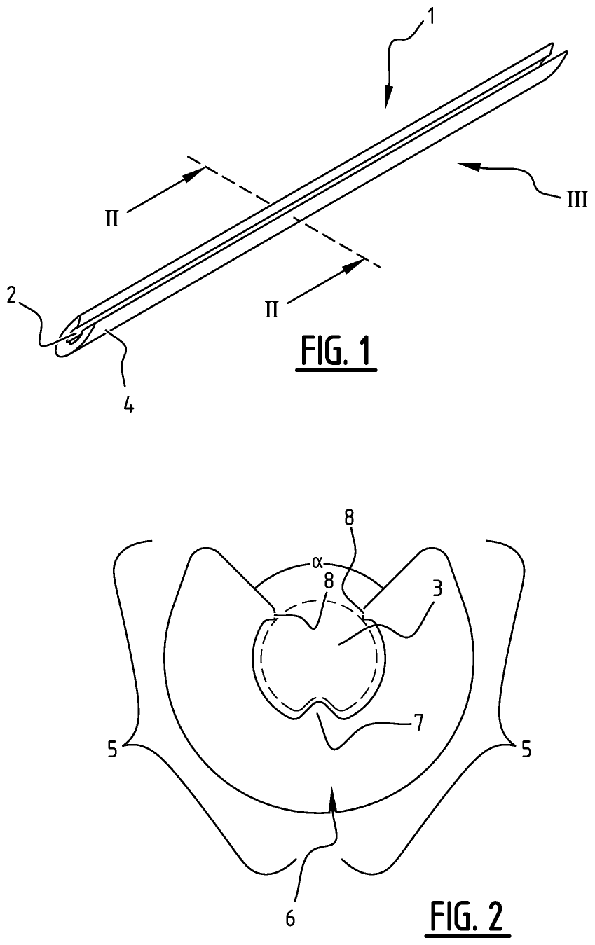

FIG. 2 shows a cross-sectional view in the direction of arrows II-II in FIG. 1;

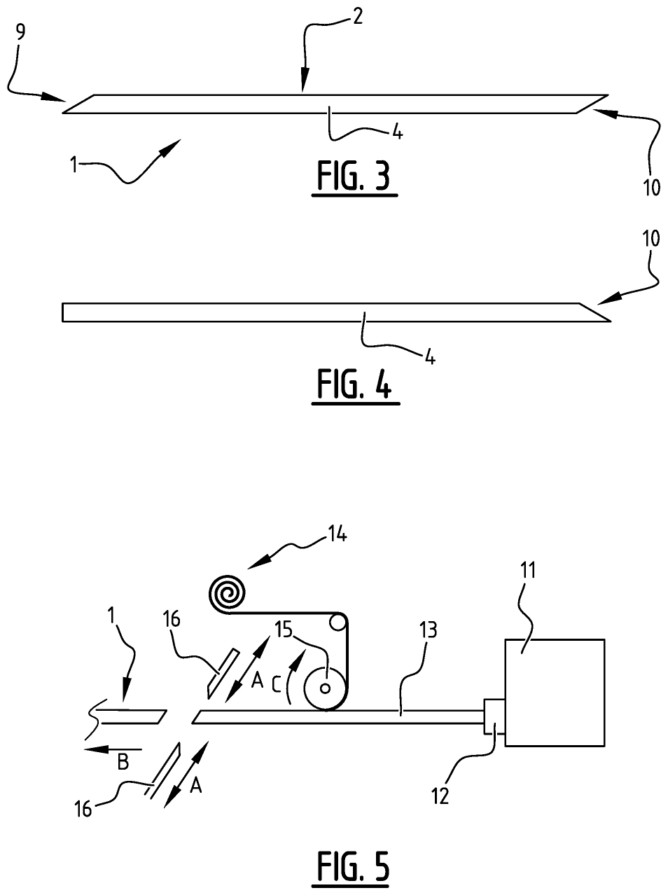

FIG. 3 shows a side view of the embodiment in FIG. 1 along arrow III;

FIG. 4 shows an alternative embodiment in side view, relative to the FIG. 3 representation; and

FIG. 5 shows a schematic representation of the production process or method in accordance with the present disclosure.

In FIGS. 1-3 a first embodiment of a Wick inserting device 1 is depicted, formed by an elongate body 4, having a wick clamp formed along essentially the entire length of the elongate body 4. Discrete wick clamps may be arranged only at or near longitudinal ends of the elongate body 4, or exhibit a pair of clamps at opposing longitudinal ends of the elongate body 4, as alternatives, or a higher number of discrete clamps than two at opposing ends of the elongate body, preferably evenly distributed over the length of the elongate body 4.

The embodiment of FIGS. 1-3 is suitable for production by continuous extrusion, since the cross sectional shape and form thereof, shown in FIG. 2, is constant in the same of the entire length of the elongate body 4. As such, the wick clamp extending over the entire length of the elongate body 4 defines an integral part of the elongate body 4. A wick can thus be engaged by the clamp(s) over a length corresponding with a length of the elongate body 4. However, the effective distance over which the clamp(s) extend(s) may be less than the whole length of the elongate body 4, provided the clamp(s) extend over or along a substantial length of the elongate body 4 to achieve one or more of the advantages of the present disclosure.

In cross section, relative to the longitudinal direction of the elongate body 4, the device comprises two curved arms 5, defining a wick accommodation 2 in a curvature of the curved arm, for accommodating a wick 3 (depicted in dashed lines). Alternatively, a single arm 5 may extend from a substantially more rigid backbone portion 6. Preferably, the arm or arms 5 span an angle, leaving a surface of the wick 3 open for dissemination of liquids, drawn up into the wick to the exterior of the device 1. Consequently, an angle α of preferably substantially more than 0° and preferably considerably less than 180° of the wick is left exposed to the exterior.

The substantially more rigid backbone portion 6 is defined where a bulge 7 is formed. When a similar bulge 7 is displaced to a distal end of one of the arms 5 in the embodiment of FIG. 2, then a single arm 5 remains.

At the distal ends of the arms 5, inward oriented protrusions 8 are formed. Together with the bulge 7, which can also be designated to define an inward oriented protrusion, the device comprises hooks 7, 8. These hooks 7, 8 and enhance engagement of the device on the wick 3.

As shown in FIG. 3, the FIG. 1 embodiment of the device 1 has pointed longitudinal ends 9, 10. Alternatively, as shown in FIG. 4, only a single longitudinal end of the elongate body 4 may be pointed, but within the scope of protection according to the appended independent claims, no longitudinal end of the elongate body 4 is required to be pointed

In FIG. 5, a schematic representation is shown of a production process, embodying a method according to the present disclosure. FIG. 5 exhibits a system, which is based on a continuous extruder 11, which may be configured, by appropriate design of an exit nozzle 12 of the continuous extruder 11, to continuously produce an extrusion product 13 having a cross sectional shape as shown, for example, in FIG. 2.

A wick supply 14, for example on a roll, is provided downstream relative to nozzle 12. The wick supply may be arranged at a remote location relative to the place where device production is performed, for remote assembly of the wicks and the devices, as described below. In a particular, in non-limiting embodiment, a roller 15 is provided to roll over the extrusion product 13 defining wick inserting devices of the present disclosure and press wick from the supply 14 into the accommodation 2 in the interior of the cross sectional shape of FIG. 2. For this purpose, roller 15 rotates in the direction of arrow C.

Further downstream, relative to the roller 15, opposing knives 16 are provided to be selectively driven in the direction of double arrows A. Alternatively, a single knife 16 may be provided. As shown in FIG. 5, knives 16 are arranged under an angle relative to a perpendicular arrangement in relation to the longitudinal direction of the extrusion product 13. In this manner, the opposing pointed ends 9, 10 of the devices according to the present disclosure are achieved. If a straight rather than a pointed end is sought, as shown in FIG. 4, one or more knives can be added under a perpendicular orientation relative to the longitudinal length of the extrusion product 13, to cut the extrusion product 13 in an alternating fashion, in combination with the knife or knives 16, that are shown in FIG. 5.

After cutting predetermined lengths of the extrusion product 13, wick inserting devices 1 are finished. These will have the predetermined length of the extrusion product 13 with an equal length of wick 3 accommodated in the interior thereof.

After cutting, finished devices 1 having even a wick already inserted into the accommodation 2 thereof are discharged in the direction of arrow B.

Alternatively, it is possible to use a pre-cut and predetermined length of the extrusion product as the elongate body 4, and for example manually insert a longer length of wick into the interior accommodation 2 of the elongate body 4. Nevertheless, an automated embodiment for inserting longer lengths of wick into shorter elongate bodies is naturally also foreseeable. Manual insertion of wicks into devices where the wick has the same length as, or is shorter than the device is also encompassed in the scope of protection for the present disclosure.

When a longer length of wick than that of the elongate body 4 is employed, it is anticipated to be considered desirable to have one of the ends of the Wick coincide with one of the ends of the elongate body 4. If the elongate body 4 has only a single pointed end 10, as shown in FIG. 4, the pointed end 10 will normally be intended to be inserted into substrate in the plant pot. In such a case, the length of the elongate body 4 will normally be selected for initial insertion into substrate in a plant pot, whereas a length of wick may extend from underneath such a plant pot to extend into a water or other liquid supply. Consequently, in such a case, one end of the wick would then be at the longitudinal pointed end 10 of the elongate body 4.

Based on the above description of specific and particular embodiments of the present disclosure, the scope of protection according to the appended claims has been substantiated, whereas clearly additional and/or alternative embodiments are possible, feasible and potentially desirable within the scope of protection according to those appended claims. Features of the specific embodiments can not and should not result in limitation of the scope of protection thereto, unless defined in independent claims, whereas even the features defined in the appended independent claims can be replaced by obvious alternatives. The main thing and objective of the present disclosure is to provide an extremely simplified form for a wick inserting device, where prior art devices were costly, intricate, complex and/or simply incapable of performing the simple task of inserting and maintaining a week in substrate in a plant pot. Through the teaching of the present disclosure, a considerable improvement is provided.

1. A wick inserting device configured to insert a wick in substrate contained in a plant pot, comprising:
an elongate body; and
at least one wick clamp configured to engage a wick at at least one longitudinal end of the elongate body,
wherein the clamp extends along the length of the elongate body.

2. The device as claimed in claim 1, wherein the clamp defines an engagement for a length of the wick along the whole of the length of the elongate body.

3. The device as claimed in claim 1, wherein the clamp is an integral part of the elongate body.

4. The device as claimed in claim 1, wherein the clamp comprises in cross section, relative to the longitudinal direction of the elongate body, at least one curved arm, defining a wick accommodation in a curvature of the curved arm.

5. The device as claimed in claim 4, wherein the curved arm spans an angle of at least 180 degrees in a radial direction, relative to a central axis of the elongate body.

6. The device as claimed in claim 4, wherein the curved arm spans an angle of less than 360 degrees in a radial direction, relative to a central axis of the elongate body.

7. The device as claimed in claim 1, wherein the clamp comprises at least one inwardly oriented hook.

8. The device as claimed in claim 1, wherein a cross sectional shape of the elongate body, relative to the longitudinal direction of the elongate body, is the same at each location along the entire length of the elongate body.

9. The device as claimed in claim 1, wherein at least one longitudinal end of the elongate body is pointed.

10. The device as claimed in claim 1, wherein the elongate body is an extrusion product.

11. An assembly of a wick and a device as claimed in claim 1.

12. A method of making a wick inserting device as claimed in claim 1, comprising
providing an elongate body; and
arranging at least one wick clamp configured to engage a wick at least at a longitudinal end of the elongate body,
wherein the clamp extends along the length of the elongate body.

13. The method as claimed in claim 12, further comprising engaging a wick with the wick clamp.

14. The method as claimed in claim 12, wherein providing the elongate body comprises extruding the elongate body.

15. The method as claimed in claim 14, further comprising extruding an extrusion product in a continuous production process and severing predetermined lengths of the extrusion product to successively provide a plurality of elongate bodies.

16. The method as claimed in claim 13, wherein engaging the wick in the wick clamp comprises rolling the wick into the wick clamp.

17. The method as claimed in claim 15, comprising rolling the wick into the wick clamp prior to severing the predetermined lengths of the extrusion product to successively provide a plurality of elongate bodies with wicks of equal length as the elongate bodies are engaged by the wick clamp.

18. The method as claimed in claim 13, further comprising providing a longer wick than a length of the elongate body and engaging the wick with the wick clamp in a relative position of the wick and the elongate body wherein the wick extends from the elongate body at at least one longitudinal end of the elongate body.

19. The method as claimed in claim 18, comprising providing the longer wick with a longitudinal end thereof to coincide with a longitudinal end of the elongate body.

20. The method as claimed in claim 13, wherein engaging the wick with the wick clamp comprises manually assembling the device and the wick.
